(19) United States
(12) Patent Application Publication
(10) Pub. No.: US 2026/0119594 A1
(43) Pub. Date: Apr. 30, 2026

(54) SYSTEM AND METHOD FOR A WIDE SCREEN USER INTERFACE

(71) Applicant: Innovasoft Tech Holdings Ltd, Nicosia (CY)

(72) Inventors: Rebecca Obrien, Laval (CA); Francisco de Azevedo, Buenos Aires (AR); Paul Weichel, Edmonton (CA); Ramsey Belmaaza, Laval (CA)

(21) Appl. No.: 19/373,416

(22) Filed: Oct. 29, 2025

Related U.S. Application Data
(60) Provisional application No. 63/713,945, filed on Oct. 30, 2024.

(51) Int. Cl. G06F 16/957; G06F 1/16; G06F 3/041; G06F 3/04842; G06F 3/04883

(52) U.S. Cl. CPC G06F 16/9577; G06F 1/1694; G06F 3/0412; G06F 3/04842; G06F 3/04883

(57) ABSTRACT

Systems, methods, and computer-readable storage media for emulating true full screen behavior in a web browser and more specifically to doing so without leveraging any full screen Application Programming Interfaces (API). A system can play, within a web browser, a video on a touchscreen display of a computing device, wherein the computing device uses an operating system which does not support full screen viewing of the video. The system can also display a full screen button on the touchscreen display over a portion of the playing video. When a user touches the full screen button via the touchscreen display, the system modifies a Document Object Model (DOM) associated with the web browser from an original configuration to a modified configuration, such that the web browser covers an entirety of a viewport of the touchscreen display and the computing device displays the video in a full screen emulator mode.

### CROSS-REFERENCE

This application claims priority to U.S. provisional patent application 63/713,945, filed Oct. 30, 2024, the contents of which are incorporated herein in their entirety.

### BACKGROUND

### 1. Technical Field

The present disclosure relates to emulating true full screen behavior in a web browser and more specifically to doing so without leveraging any full screen Application Programming Interfaces (API).

### 2. Introduction

An Operating System (OS) is a fundamental system software that acts as an intermediary between computer hardware and application software. iOS is a mobile operating system developed by APPLE exclusively for its devices. The APPLE operating systems often do not allow requests to native full screen API on specific Document Object Model (DOM) element types, such as HTMLDivElement. Although these limitations were somewhat lifted on iPadOS 17, this is not yet the case for iOS 17 on iPhone devices as of this writing.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: playing, within a web browser, a video on a touchscreen display of a computing device, resulting in a playing video, wherein the computing device uses an operating system which does not support full screen viewing of the video; displaying a full screen button on the touchscreen display over a portion of the playing video; and upon receiving a touch over the full screen button via the touchscreen display, modifying a Document Object Model (DOM) associated with the web browser from an original configuration to a modified configuration, such that the web browser displays the video in a full screen emulator mode.

A system configured to perform the concepts disclosed herein can include: at least one processor; a touchscreen display; a non-transitory computer-readable storage medium having instructions stored which, when executed by the at least one processor, cause the at least one processor to perform operations comprising: playing, within a web browser, a video on the touchscreen display of the system, resulting in a playing video, wherein the system uses an operating system which does not support full screen viewing of the video; displaying a full screen button on the touchscreen display over a portion of the playing video; and upon receiving a touch over the full screen button via the touchscreen display, modifying a Document Object Model (DOM) associated with the web browser from an original configuration to a modified configuration, such that the web browser displays the video in a full screen emulator mode.

A non-transitory computer-readable storage medium configured as disclosed herein can have instructions stored which, when executed by at least one processor, cause the at least one processor to perform operations which include: playing, within a web browser, a video on a touchscreen display of a computing device, resulting in a playing video, wherein the computing device uses an operating system which does not support full screen viewing of the video; displaying a full screen button on the touchscreen display over a portion of the playing video; and upon receiving a touch over the full screen button via the touchscreen display, modifying a Document Object Model (DOM) associated with the web browser from an original configuration to a modified configuration, such that the web browser displays the video in a full screen emulator mode.

### BRIEF DESCRIPTION OF THE DRAWINGS

FIG. 1 illustrates a first example process of emulating a full screen behavior;

FIG. 2 illustrates a second example process of emulating a full screen behavior;

FIG. 3 illustrates examples of a device configured as disclosed herein before and after device rotation;

FIG. 4A illustrates an example of engaging full screen emulation by rotating from portrait mode to landscape mode;

FIG. 4B illustrates an example of disengaging full screen emulation by rotating from landscape mode to portrait mode;

FIG. 4C illustrates an example of swiping down to disengage full screen emulation mode;

FIG. 4D illustrates an example of swiping up to engage full screen emulation mode;

FIG. 5 illustrates an example method embodiment; and

FIG. 6 illustrates an example computer system.

### DETAILED DESCRIPTION

Various embodiments of the disclosure are described in detail below. While specific implementations are described, this is done for illustration purposes only. Other components and configurations may be used without parting from the spirit and scope of the disclosure.

When a device goes full screen, it typically means that the display is maximized to fill the entire screen area, hiding status bars, navigation bars, and other interface elements that might obstruct the view. This creates an immersive experience where the content fills the entire screen, providing an unobstructed and engaging visual field.

In video playback, full screen mode is often automatically activated by the video player, while in other apps, users may need to tap a specific button within the app's interface to enter full screen mode. The exact process may vary depending on the app and Operating System (OS) version, but the general goal is to enhance the viewing or gaming experience by providing a more expansive view of the content.

However, in certain OS versions, the full screen mode is not automatically activated. For example, as of this writing, iOS 17 on iPhone devices do not allow for full screen video viewing. this is one example, and the systems and methods disclosed herein can apply to any OS which does not allow for full screen viewing. Systems configured as disclosed herein allow for emulation of full screen mode via the processes described below.

A Document Object Model (DOM) is a cross-platform and language-independent Application Programming Interface (API) that treats an HyperText Markup Language (HTML) or Extensible Markup Language (XML) document as a tree structure, wherein each node is an object representing a part of the document. The DOM represents a document with a logical tree. Each branch of the tree ends in a node, and each node contains objects. DOM methods allow programmatic access to the tree; with them one can change the structure, style or content of a document, which in turn can modify how objects are displayed on a screen. Nodes can have event handlers (also known as event listeners) attached to them. Once an event is triggered, the event handlers get executed.

To identify/track how web pages are operating, programmers can “spy” on a DOM element or track when the DOM executes in a similar manner to how programmers debug or parse through executing code. For example, programmers can implement additional code (such as, but not limited to JAVASCRIPT) which, when executed, identifies when certain elements within a DOM are called or triggered.

In this case, the implementation of the Fake Fullscreen for OS feature (i.e., full screen emulation for those OS versions which do not support full screen) relies on four different components:

### 1. Fullscreen Button

A button that prompts a swipe action by displaying a tooltip (i.e., a small, informative text box that appears when a user hovers over, focuses on, or taps an element in a user interface) on tap. This button, in addition to displaying the tooltip on tap, will also trigger entry into fake full screen mode when the user swipes on it (i.e., a “swipe up” action).

### 2. Address Bar Controller

A script (e.g., JAVASCRIPT) that keeps track of whether the browser's (e.g., SAFARI, iOS's web browser) address bar becomes hidden. This is accomplished by monitoring the height of a Document Object Model (DOM) spy element that takes up the exact size of the viewport, which includes the address bar whenever it is fully or partially visible. Any changes in the height of this element are treated as tell-tale signs of a change in the address bar's visibility. In other words, the script tracks if the height of the address bar changes, with changes indicating that the address bar has become hidden.

### 3. Fake Fullscreen Controller

A script receives inputs from both the Fullscreen Button and the Address Bar Controller, but also from other modules in a video player (such as but not limited to an Orientation Controller and a Swipe Controller) to be able to enter and exit this simulated full screen state. This Fake Fullscreen Controller script can be part of the same script as the Address Bar Controller script, or (preferably) can be a distinct script. Preferably the scripts are running in parallel.

### 4. A Container in Fixed Position

Once the address bar hides following a user's swipe up action, the entire player container is stripped from its position in the DOM, attached to the body element (i.e., the main content of an HTML document, which contains the content of the document, the body element only appearing once in the DOM), and set to a fixed position in the browser so that it fills the entire viewport. The player container can also be given a very large height (e.g., larger than the viewport (the size in pixels that developers use for web page layout)/screen height)) to allow users to swipe up or down at will without accidentally triggering the address bar to become visible again and trigger an exit event.

While the full screen state is being emulated (i.e., while in the fake full screen state) the full screen button can be displayed, preferably in a corner of the screen. In some configurations, the full screen button can disappear until the user taps/swipes the screen, or until the video is complete. To exit the fake full screen state the user can again swipe the full screen button. Alternatively, in some configurations rotating the screen while in a fake full screen mode (e.g., from portrait to landscape or from landscape to portrait) can trigger exiting of the fake full screen mode.

Once the user exits the fake full screen state, the system places the player container back in its original DOM position (i.e., rewriting/updating the DOM), thereby restoring the web page's scroll Y position.

Full screen mode, as described herein, can refer to a display setting that makes an application or window take up the entire computer or device screen, hiding the operating system's usual desktop elements like the taskbar and other open windows. It provides a more immersive and distraction-free experience, making it ideal for activities like watching videos, playing games, or giving presentations. In other configurations, full screen mode may leave the address bar of a web browser visible, while dedicating the remainder of the screen to the full screen mode for the video/game/etc.

As used herein, a “touch” and/or “gesture” on a touch screen can include taps, swipes, pinches, or any other action where the user presses a finger/digit to the touch screen in a pattern or movement one or more times. While specific examples are given herein of a tap or swipe, under most configurations these examples can also use other forms of touch unless expressly identified as incompatible.

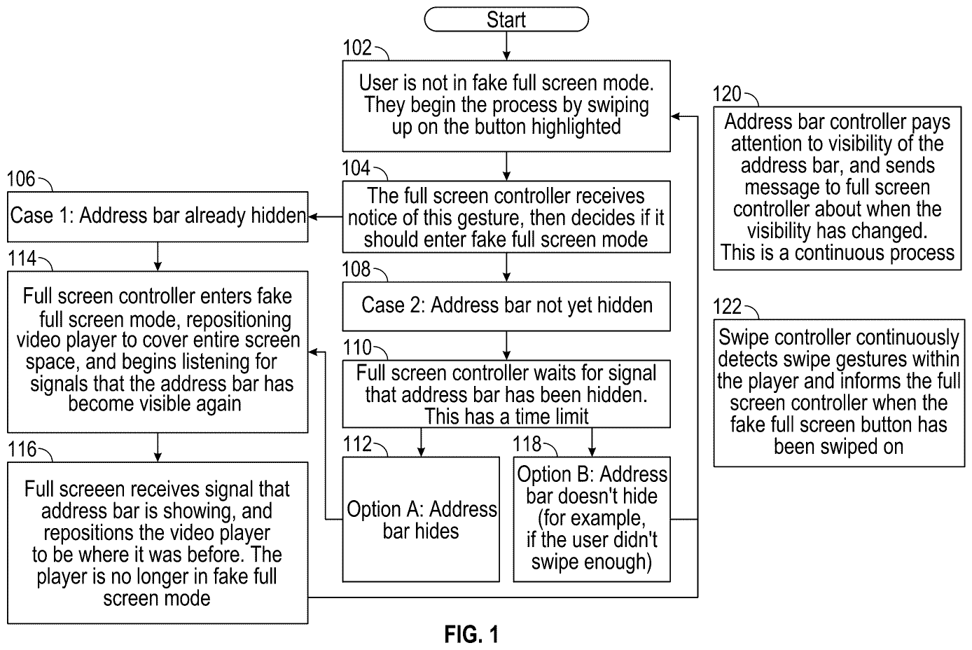

FIG. 1 illustrates a first example process of emulating a full screen behavior. At the start, the user is not in a fake full screen mode 102, and the user begins the process by swiping up on a button highlighted on the video. A full screen controller receives notice of this gesture 104, then decides if it should enter the fake full screen mode. In a first case 106, the address bar of the user's browser is already hidden, and the full screen controller enters the fake full screen mode 114, repositioning the video player to cover the entire screen by modifying the DOM of the web page from which the video is being played such that the DOM positions the video at a different location (i.e., the DOM is modified from an original configuration to a temporary/modified configuration), and begins listening for signals that the address bar of the web browser being used to navigate the Internet has become visible. The full screen controller can later receive a signal 116 that the address bar for the web browser is showing, and reposition the video player to be where it was before (i.e., modify the DOM again, returning the DOM to the original configuration). At this point the video player is no longer in a fake full screen state and the process can restart.

In a second case, the address bar of the user's browser is not yet hidden 118, and the full screen controller waits for a signal that the address bar has been hidden (this process can have a time limit). In some instances, the address bar becomes hidden (as discussed above). In other cases (e.g., when the user doesn't swipe on the button sufficiently), the address bar does not hide and the process restarts.

The address bar controller 120 pays attention to visibility of the address bar and sends message(s) to the full screen controller about when the visibility has changed. This is a continuous process.

A swipe controller 122 continuously detects swipe gestures within the player, and informs the full screen controller when the fake full screen button has been swiped on.

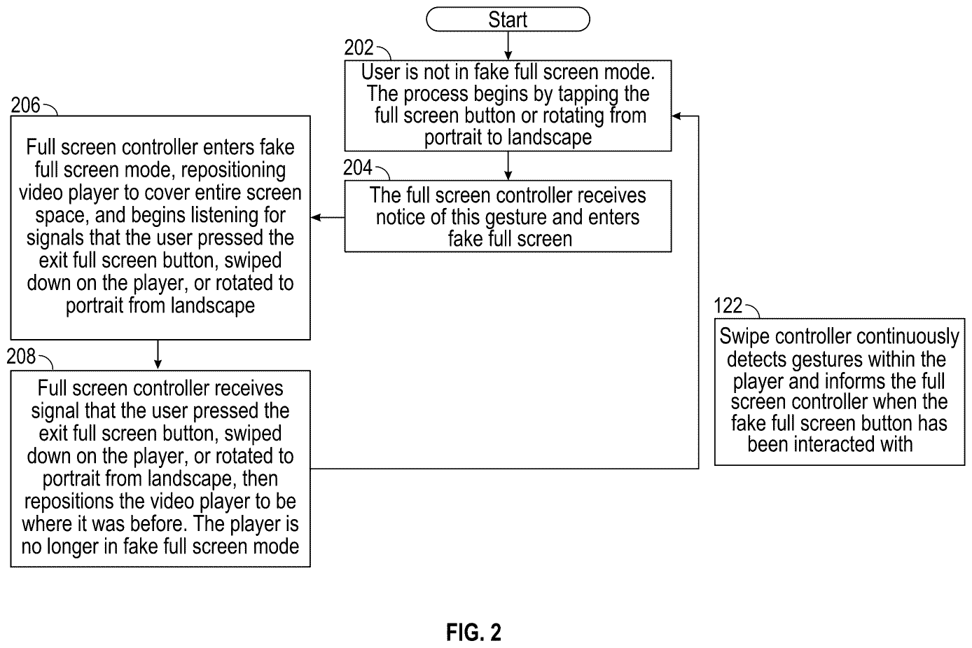

FIG. 2 illustrates a second example process of emulating a full screen behavior. The swipe controller 122 can operate in the same manner as that described with respect to FIG. 1. In addition, the swipe controller 122 can detect gestures (e.g., touches, swipes, pinches, etc.) on the touchscreen of the computer device. In this second example process, the address bar controller 120 of FIG. 1 is no longer present.

In this example, the user begins with their device not in a fake full screen mode 202. The user begins the process of initiating the fake full screen mode by tapping on a full screen button. In some configurations, in addition to tapping on the full screen button, the user can rotate the device (e.g., a smartphone or tablet computer) from portrait orientation to landscape orientation or vice versa to initiate the fake full screen mode (portrait orientation being where a vertical length is longer than a horizontal length of the device). A full screen controller receives notice of this gesture 204 and the full controller enters the fake full screen mode 206, repositioning the video player by editing the DOM of the webpage such that the video player covers the entire screen space. The full screen controller also begins listening 206 for signals that the user pressed an exit full screen button, swiped down on the player, or rotated the device to portrait from landscape (or vice versa). When the full screen controller receives the signal that the exit full screen button was clicked 208, that the user rotated the device, or swiped down on the player, the system then repositions the video player to be where it was before. In other words, the system modifies the DOM back to the original configuration. At this point the video player is no longer in a fake full screen state and the process can restart.

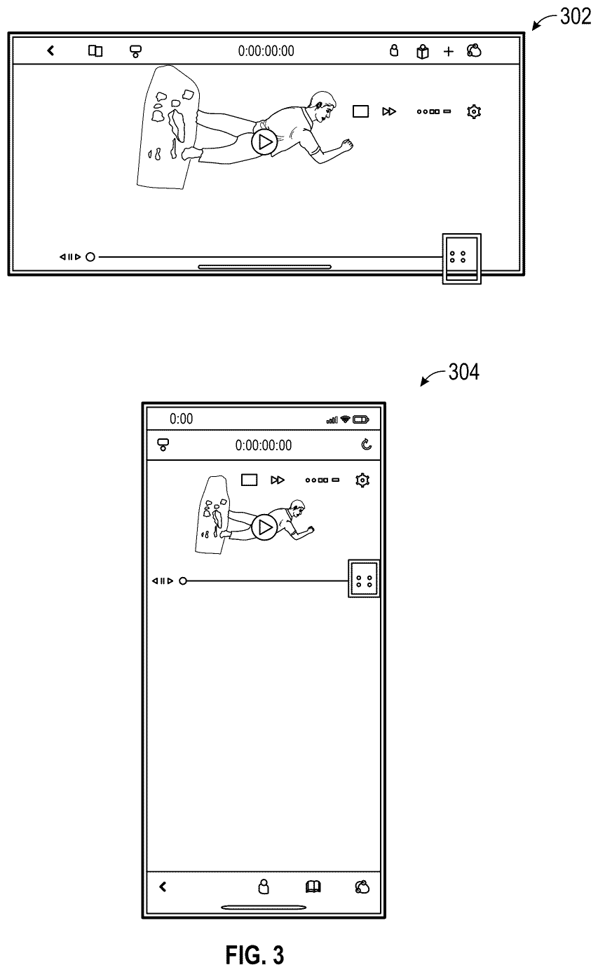

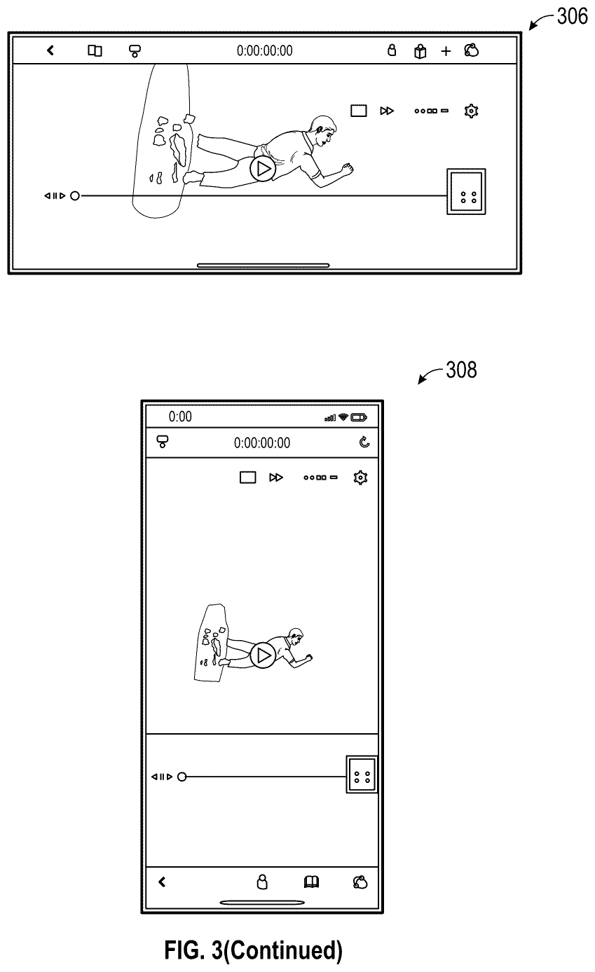

FIG. 3 illustrates examples of a device configured as disclosed herein before and after device rotation. In 302, we see an exemplary device with a video playing in a web browser, the device oriented to landscape mode before entering the fake full screen mode, with the full screen button 310 in the bottom right of the video player. In 306, we see the fake full screen mode in landscape orientation, with the exit full screen button 312 again in the bottom right of the video player. In some configurations, the fake full screen mode may cover up the address bar such that it is no longer visible, whereas in other configurations (such as that illustrated), the address bar may continue to be displayed on the screen while in the fake full screen mode.

The same principles apply when the device is in portrait mode. In 304, we see an exemplary device with a video player playing in the web browser (the web address at the top of the example), the device oriented to portrait mode before entering the fake full screen mode, with the full screen button 310 in the bottom right of the video player. In 308, we see the fake full screen mode again in portrait orientation, with the exit full screen button 312 again in the bottom right of the video player. Again, in some configurations, the fake full screen mode may cover up the address bar such that it is no longer visible, whereas in other configurations (such as that illustrated), the address bar may continue to be displayed on the screen while in the fake full screen mode.

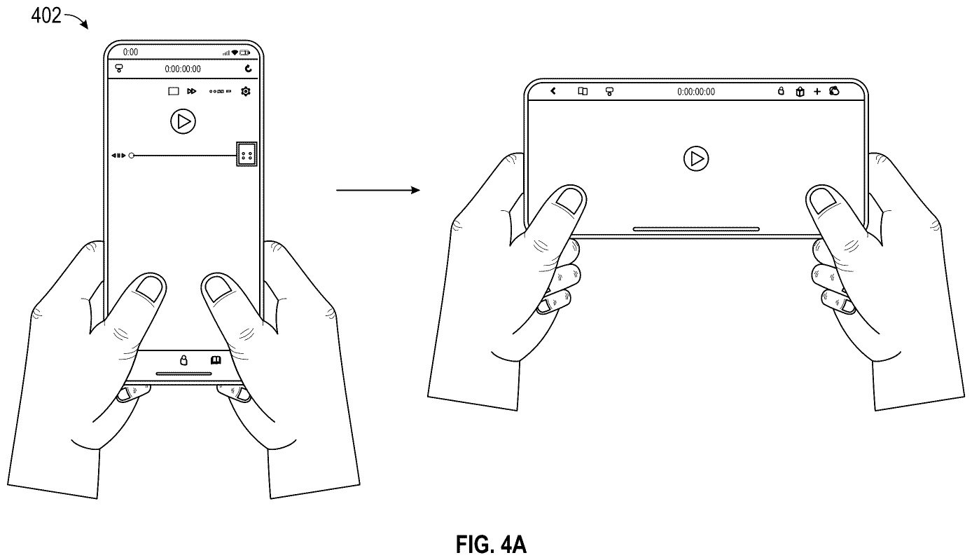

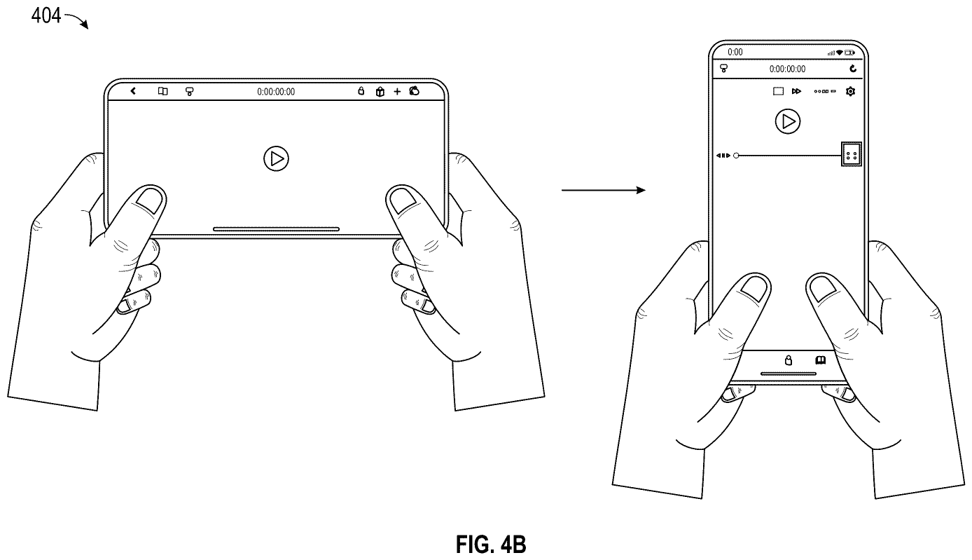

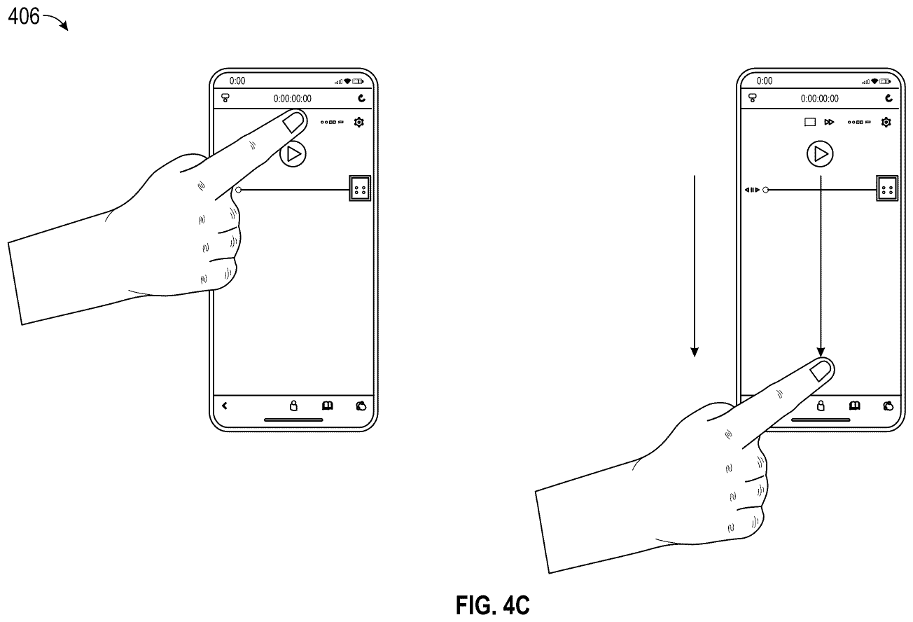

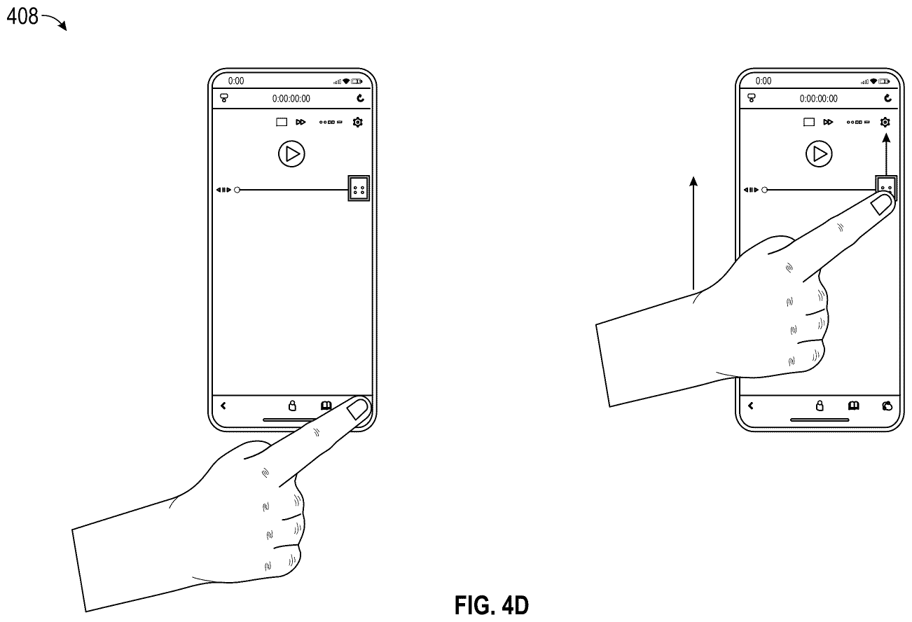

FIG. 4 illustrates examples of engaging/disengaging full screen emulation by rotating the device. In FIG. 4A 402 the figures provide an example of switching from portrait to landscape orientation, which can trigger entry into the fake full screen mode and/or trigger exit of the fake full screen mode. Likewise, in FIG. 4B 404 the figures provide an example of switching from landscape to portrait orientation, which can again trigger entry into the fake full screen mode and/or trigger exit of the fake full screen mode. In FIG. 4C 406, the figures provide an example of a swipe down gesture on a smartphone with a touch display. A swipe down can be used to exit from the fake full screen mode. In FIG. 4D 408, the figures provide an example of a swipe up gesture on a smartphone with a touch display, the swipe up gesture being used to enter the full screen emulation mode. It is noted that in some configurations, swiping on the full screen button (e.g., as illustrated in FIGS. 4C and/or in 4D) can be replaced by pressing on the buttons rather than swiping. Likewise, in some configurations the user can rotate the device, such as illustrated in FIGS. 4A and 4B, rather than swiping on the full screen button.

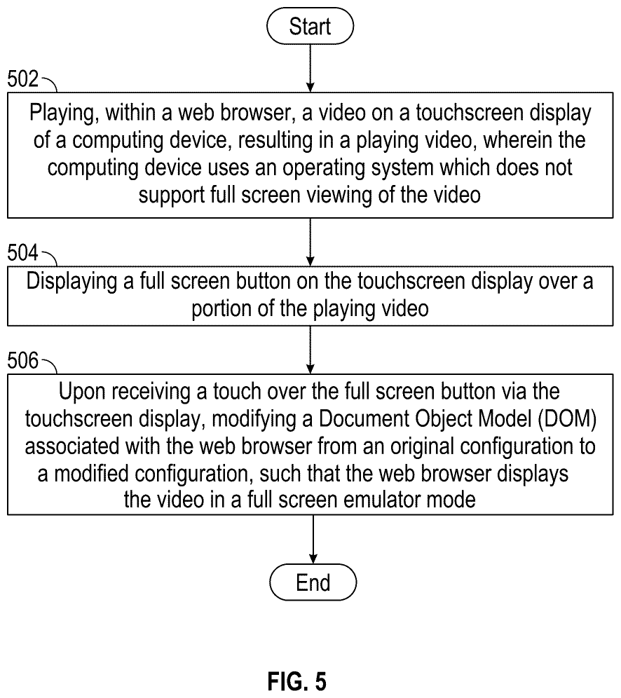

FIG. 5 illustrates an example method embodiment. As illustrated, the method begins by playing, within a web browser, a video on a touchscreen display of a computing device, resulting in a playing video, wherein the computing device uses an operating system which does not support full screen viewing of the video (502). Next, the method includes displaying a full screen button on the touchscreen display over a portion of the playing video (504). The illustrated method then concludes by, upon receiving a touch over the full screen button via the touchscreen display, modifying a Document Object Model (DOM) associated with the web browser from an original configuration to a modified configuration, such that the web browser displays the video in a full screen emulator mode (506).

In some configurations, a player container of the web browser is given a DOM height within the DOM which exceeds a viewport height of the viewport. That is, when the DOM is modified to enable the fake full screen mode, the dimensions of the player container are larger than the viewable area of the screen (i.e., the viewport), such that nothing is visible but the video.

In some configurations, the illustrated method can further include: while the computing device displays the video in the full screen emulator mode, displaying the full screen button; and upon receiving a second touch over the full screen button while the computing device displays the video in the full screen emulator mode: exiting the full screen emulator mode; and modifying the DOM, such that the DOM changes from the modified configuration to the original configuration.

In some configurations, the illustrated method can further include: while the computing device displays the video in the full screen emulator mode, receiving a signal that the computing device has undergone a rotation from one of a portrait mode to a landscape mode or the landscape mode to the portrait mode; and based on the rotation: exiting the full screen emulator mode; and modifying the DOM, such that the DOM changes from the modified configuration to the original configuration.

In some configurations, the operating system is an iOS operating system.

In some configurations, the computing device is a smartphone or a tablet computer.

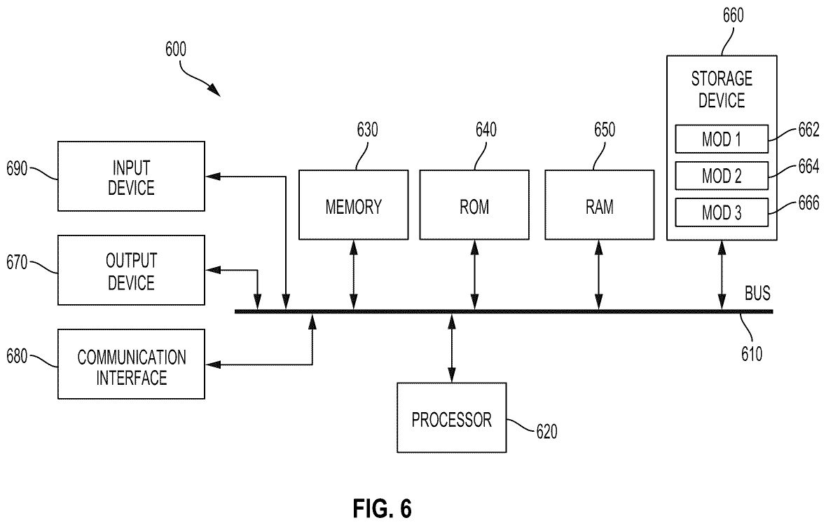

With reference to FIG. 6, an exemplary system includes a computing device 600 (such as a general-purpose computing device), including a processing unit (CPU or processor) 620 and a system bus 610 that couples various system components including the system memory 630 such as read-only memory (ROM) 640 and random access memory (RAM) 650 to the processor 620. The computing device 600 can include a cache of high-speed memory connected directly with, in close proximity to, or integrated as part of the processor 620. The computing device 600 copies data from the system memory 630 and/or the storage device 660 to the cache for quick access by the processor 620. In this way, the cache provides a performance boost that avoids processor 620 delays while waiting for data. These and other modules can control or be configured to control the processor 620 to perform various actions. Other system memory 630 may be available for use as well. The system memory 630 can include multiple different types of memory with different performance characteristics. It can be appreciated that the disclosure may operate on a computing device 600 with more than one processor 620 or on a group or cluster of computing devices networked together to provide greater processing capability. The processor 620 can include any general-purpose processor and a hardware module or software module, such as module 1 662, module 2 664, and module 3 666 stored in storage device 660, configured to control the processor 620 as well as a special-purpose processor where software instructions are incorporated into the actual processor design. The processor 620 may essentially be a completely self-contained computing system, containing multiple cores or processors, a bus, memory controller, cache, etc. A multi-core processor may be symmetric or asymmetric.

The system bus 610 may be any of several types of bus structures including a memory bus or memory controller, a peripheral bus, and a local bus using any of a variety of bus architectures. A basic input/output (BIOS) stored in memory ROM 640 or the like, may provide the basic routine that helps to transfer information between elements within the computing device 600, such as during start-up. The computing device 600 further includes storage devices 660 such as a hard disk drive, a magnetic disk drive, an optical disk drive, tape drive or the like. The storage device 660 can include software modules 662, 664, 666 for controlling the processor 620. Other hardware or software modules are contemplated. The storage device 660 is connected to the system bus 610 by a drive interface. The drives and the associated computer-readable storage media provide nonvolatile storage of computer-readable instructions, data structures, program modules and other data for the computing device 600. In one aspect, a hardware module that performs a particular function includes the software component stored in a tangible computer-readable storage medium in connection with the necessary hardware components, such as the processor 620, system bus 610, output device 670 (such as a display or speaker), and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the computing device 600 is a small, handheld computing device, a desktop computer, or a computer server.

Although the exemplary embodiment described herein employs the storage device 660 (such as a hard disk), other types of computer-readable media which can store data that are accessible by a computer, such as magnetic cassettes, flash memory cards, digital versatile disks, cartridges, random access memories (RAMs) 650, and read-only memory (ROM) 640, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 600, an input device 690 represents any number of input mechanisms, such as a microphone for speech, a touch-sensitive screen for gesture or graphical input, keyboard, mouse, motion input, speech and so forth. An output device 670 can also be one or more of a number of output mechanisms known to those of skill in the art. In some instances, multimodal systems enable a user to provide multiple types of input to communicate with the computing device 600. The communications interface 680 generally governs and manages the user input and system output. There is no restriction on operating on any particular hardware arrangement and therefore the basic features here may easily be substituted for improved hardware or firmware arrangements as they are developed.

The computing device 600 may be described in the general context of computer system-executable instructions, such as program modules, being executed by a computer system. Generally, program modules may include routines, programs, objects, components, logic, data structures, and so on that perform particular tasks or implement particular abstract data types. In configurations where the computing device 600 is used in a distributed cloud computing environment (such as where the computing device 600 utilizes one or more servers) where tasks are performed by remote processing devices that are linked through a communications network. In a distributed cloud computing environment, program modules may be located in both local and remote computer system storage media including memory storage devices.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

A method comprising: playing, within a web browser, a video on a touchscreen display of a computing device, resulting in a playing video, wherein the computing device uses an operating system which does not support full screen viewing of the video; displaying a full screen button on the touchscreen display over a portion of the playing video; and upon receiving a touch over the full screen button via the touchscreen display, modifying a Document Object Model (DOM) associated with the web browser from an original configuration to a modified configuration, such that the web browser displays the video in a full screen emulator mode.

The method of any preceding clause, wherein a player container of the web browser is given a DOM height within the DOM which exceeds a viewport height of the viewport.

The method of any preceding clause, further comprising: while the computing device displays the video in the full screen emulator mode, displaying the full screen button; and upon receiving a second touch over the full screen button while the computing device displays the video in the full screen emulator mode: exiting the full screen emulator mode; and modifying the DOM, such that the DOM changes from the modified configuration to the original configuration.

The method of any preceding clause, further comprising: while the computing device displays the video in the full screen emulator mode, receiving a signal that the computing device has undergone a rotation from one of a portrait mode to a landscape mode or the landscape mode to the portrait mode; and based on the rotation: exiting the full screen emulator mode; and modifying the DOM, such that the DOM changes from the modified configuration to the original configuration.

The method of any preceding clause, wherein the operating system is an iOS operating system.

The method of any preceding clause, wherein the computing device is a smartphone.

The method of any preceding clause, wherein the computing device is a tablet computer.

A system comprising: at least one processor; a touchscreen display; a non-transitory computer-readable storage medium having instructions stored which, when executed by the at least one processor, cause the at least one processor to perform operations comprising: playing, within a web browser, a video on the touchscreen display of the system, resulting in a playing video, wherein the system uses an operating system which does not support full screen viewing of the video; displaying a full screen button on the touchscreen display over a portion of the playing video; and upon receiving a touch over the full screen button via the touchscreen display, modifying a Document Object Model (DOM) associated with the web browser from an original configuration to a modified configuration, such that the web browser displays the video in a full screen emulator mode.

The system of any preceding clause, wherein a player container of the web browser is given a DOM height within the DOM which exceeds a viewport height of the viewport.

The system of any preceding clause, the non-transitory computer-readable storage medium having additional instructions stored which, when executed by the at least one processor, cause the at least one processor to perform operations comprising: while the system displays the video in the full screen emulator mode, displaying the full screen button; and upon receiving a second touch over the full screen button while the system displays the video in the full screen emulator mode: exiting the full screen emulator mode; and modifying the DOM, such that the DOM changes from the modified configuration to the original configuration.

The system of any preceding clause, the non-transitory computer-readable storage medium having additional instructions stored which, when executed by the at least one processor, cause the at least one processor to perform operations comprising: while the system displays the video in the full screen emulator mode, receiving a signal that the system has undergone a rotation from one of a portrait mode to a landscape mode or the landscape mode to the portrait mode; and based on the rotation: exiting the full screen emulator mode; and modifying the DOM, such that the DOM changes from the modified configuration to the original configuration.

The system of any preceding clause, wherein the operating system is an iOS operating system.

The system of any preceding clause, wherein the system is a smartphone.

The system of any preceding clause, wherein the system is a tablet computer.

A non-transitory computer-readable medium having instructions stored which, when executed by at least one processor, cause the at least one processor to perform operations comprising: playing, within a web browser, a video on a touchscreen display of a computing device, resulting in a playing video, wherein the computing device uses an operating system which does not support full screen viewing of the video; displaying a full screen button on the touchscreen display over a portion of the playing video; and upon receiving a touch over the full screen button via the touchscreen display, modifying a Document Object Model (DOM) associated with the web browser from an original configuration to a modified configuration, such that the web browser displays the video in a full screen emulator mode.

The non-transitory computer-readable medium of any preceding clause, wherein a player container of the web browser is given a DOM height within the DOM which exceeds a viewport height of the viewport.

The non-transitory computer-readable medium of any preceding clause, having additional instructions stored which, when executed by the at least one processor, cause the at least one processor to perform operations comprising: while the computing device displays the video in the full screen emulator mode, displaying the full screen button; and upon receiving a second touch over the full screen button while the computing device displays the video in the full screen emulator mode: exiting the full screen emulator mode; and modifying the DOM, such that the DOM changes from the modified configuration to the original configuration.

The non-transitory computer-readable medium of any preceding clause, having additional instructions stored which, when executed by the at least one processor, cause the at least one processor to perform operations comprising: while the computing device displays the video in the full screen emulator mode, receiving a signal that the computing device has undergone a rotation from one of a portrait mode to a landscape mode or the landscape mode to the portrait mode; and based on the rotation: exiting the full screen emulator mode; and modifying the DOM, such that the DOM changes from the modified configuration to the original configuration.

The non-transitory computer-readable medium of any preceding clause, wherein the operating system is an iOS operating system.

The non-transitory computer-readable medium of any preceding clause, wherein the computing device is a smartphone.

A method comprising: playing, within a web browser, a video on a touchscreen display of a computing device, resulting in a playing video, wherein the computing device uses an operating system which does not support full screen viewing of the video; displaying a full screen button on the touchscreen display over a portion of the playing video; upon receiving a touch over the full screen button via the touchscreen display, modifying a Document Object Model (DOM) associated with the web browser from an original configuration to a modified configuration, such that the web browser displays the video in a full screen emulator mode; monitoring (or listening) for a signal that an address bar has become visible; and upon receiving the signal that the address bar has become visible, modifying the DOM from the modified position to the original position, such that the full screen emulator mode is terminated.

A method comprising: playing, within a web browser, a video on a touchscreen display of a computing device, resulting in a playing video, wherein the computing device uses an operating system which does not support full screen viewing of the video; displaying a full screen button on the touchscreen display over a portion of the playing video; upon receiving a touch over the full screen button via the touchscreen display, modifying a Document Object Model (DOM) associated with the web browser from an original configuration to a modified configuration, such that the web browser displays the video in a full screen emulator mode; monitoring (or listening) for a signal that a user has pressed an exit full screen button or rotated the computing device from a landscape mode to a portrait mode (or vice versa); and upon receiving the signal, modifying the DOM from the modified position to the original position, such that the full screen emulator mode is terminated.

We claim:

1. A method comprising:
playing, within a web browser, a video on a touchscreen display of a computing device, resulting in a playing video, wherein the computing device uses an operating system which does not support full screen viewing of the video;
displaying a full screen button on the touchscreen display over a portion of the playing video; and
upon receiving a touch over the full screen button via the touchscreen display, modifying a Document Object Model (DOM) associated with the web browser from an original configuration to a modified configuration, such that the web browser displays the video in a full screen emulator mode.

2. The method of claim 1, wherein a player container of the web browser is given a DOM height within the DOM which exceeds a viewport height of a viewport of the touchscreen display.

3. The method of claim 1, further comprising:
while the computing device displays the video in the full screen emulator mode, displaying the full screen button; and
upon receiving a second touch over the full screen button while the computing device displays the video in the full screen emulator mode:
exiting the full screen emulator mode; and
modifying the DOM, such that the DOM changes from the modified configuration to the original configuration.

4. The method of claim 1, further comprising:
while the computing device displays the video in the full screen emulator mode, receiving a signal that the computing device has undergone a rotation from one of a portrait mode to a landscape mode or the landscape mode to the portrait mode; and
based on the rotation:
exiting the full screen emulator mode; and
modifying the DOM, such that the DOM changes from the modified configuration to the original configuration.

5. The method of claim 1, wherein the operating system is an iOS operating system.

6. The method of claim 1, wherein the computing device is a smartphone.

7. The method of claim 1, wherein the computing device is a tablet computer.

8. A system comprising:
at least one processor;
a touchscreen display;
a non-transitory computer-readable storage medium having instructions stored which, when executed by the at least one processor, cause the at least one processor to perform operations comprising:
playing, within a web browser, a video on the touchscreen display of the system, resulting in a playing video, wherein the system uses an operating system which does not support full screen viewing of the video;
displaying a full screen button on the touchscreen display over a portion of the playing video; and
upon receiving a touch over the full screen button via the touchscreen display, modifying a Document Object Model (DOM) associated with the web browser from an original configuration to a modified configuration, such that the web browser displays the video in a full screen emulator mode.

9. The system of claim 8, wherein a player container of the web browser is given a DOM height within the DOM which exceeds a viewport height of a viewport of the touchscreen display.

10. The system of claim 8, the non-transitory computer-readable storage medium having additional instructions stored which, when executed by the at least one processor, cause the at least one processor to perform operations comprising:
while the system displays the video in the full screen emulator mode, displaying the full screen button; and
upon receiving a second touch over the full screen button while the system displays the video in the full screen emulator mode:
exiting the full screen emulator mode; and
modifying the DOM, such that the DOM changes from the modified configuration to the original configuration.

11. The system of claim 8, the non-transitory computer-readable storage medium having additional instructions stored which, when executed by the at least one processor, cause the at least one processor to perform operations comprising:
while the system displays the video in the full screen emulator mode, receiving a signal that the system has undergone a rotation from one of a portrait mode to a landscape mode or the landscape mode to the portrait mode; and
based on the rotation:
exiting the full screen emulator mode; and
modifying the DOM, such that the DOM changes from the modified configuration to the original configuration.

12. The system of claim 8, wherein the operating system is an iOS operating system.

13. The system of claim 8, wherein the system is a smartphone.

14. The system of claim 8, wherein the system is a tablet computer.

15. A non-transitory computer-readable medium having instructions stored which, when executed by at least one processor, cause the at least one processor to perform operations comprising:
playing, within a web browser, a video on a touchscreen display of a computing device, resulting in a playing video, wherein the computing device uses an operating system which does not support full screen viewing of the video;
displaying a full screen button on the touchscreen display over a portion of the playing video; and
upon receiving a touch over the full screen button via the touchscreen display, modifying a Document Object Model (DOM) associated with the web browser from an original configuration to a modified configuration, such that the web browser displays the video in a full screen emulator mode.

16. The non-transitory computer-readable medium of claim 15, wherein a player container of the web browser is given a DOM height within the DOM which exceeds a viewport height of a viewport of the touchscreen display.

17. The non-transitory computer-readable medium of claim 15, having additional instructions stored which, when executed by the at least one processor, cause the at least one processor to perform operations comprising:
while the computing device displays the video in the full screen emulator mode, displaying the full screen button; and
upon receiving a second touch over the full screen button while the computing device displays the video in the full screen emulator mode:
exiting the full screen emulator mode; and
modifying the DOM, such that the DOM changes from the modified configuration to the original configuration.

18. The non-transitory computer-readable medium of claim 15, having additional instructions stored which, when executed by the at least one processor, cause the at least one processor to perform operations comprising:
while the computing device displays the video in the full screen emulator mode, receiving a signal that the computing device has undergone a rotation from one of a portrait mode to a landscape mode or the landscape mode to the portrait mode; and
based on the rotation:
exiting the full screen emulator mode; and
modifying the DOM, such that the DOM changes from the modified configuration to the original configuration.

19. The non-transitory computer-readable medium of claim 15, wherein the operating system is an iOS operating system.

20. The non-transitory computer-readable medium of claim 15, wherein the computing device is a smartphone.
